(19) United States
(12) Patent Application Publication
(10) Pub. No.: US 2013/0087258 A1
(43) Pub. Date: Apr. 11, 2013

(54) Tire Protection Device

(71) Applicant: Ching Huang Tsai, Tainan City (TW)

(72) Inventor: Ching Huang Tsai, Tainan City (TW)

(21) Appl. No.: 13/632,189

(22) Filed: Oct. 1, 2012

(30) Foreign Application Priority Data
Oct. 7, 2011 (TW) 100218827

(51) Int. Cl. B60C 19/00

(52) U.S. Cl. 152/187

(57) ABSTRACT

A tire protection device includes an annular wall and two centripetal lip portions extending inwards from two side ends of the annular wall respectively. The annular wall includes an accommodating space internally for holding a tire. The annular wall further includes an external surface with unspecified textures and patterns and an internal surface with patterns matching tread patterns on a tread of the tire. The lip portions compactly cover two sidewalls of the tire. The tire protection device is designed to prevent not only a tire's tread from wear caused by a direct friction with pavements but also a driver from frequent replacement of tires and optimize aesthetics of tires.

### BACKGROUND OF THE INVENTION

1. Field of the Invention

The present invention relates to a tire protection device and, more particularly, to an annulus tire protection device integrated with a tire externally to avoid the tire from wear out of direct friction with pavements and to optimize aesthetics of the tire.

2. Description of the Related Art

The treads of general tires installed on a running car directly rub on pavements and are fast worn, so that old tires are routinely replaced and become lots of abandoned tires which enormously affect the environment and increase expenses of drivers. On the other hand, visual effects of general tires with black appearance are also weakened.

### BRIEF SUMMARY OF THE INVENTION

Therefore, an objective of the present invention is to provide a tire protection device to improve the aforementioned shortcoming and deficiency of the prior art. The tire protection device of the present invention is adapted for covering a tire's external tread to minimize direct friction-induced wear between the tread of the tire and pavements, frequent replacement of tires, and any abandoned environmental-unfriendly tires. Furthermore, the tire protection device of the present invention is capable of optimizing and diversifying an appearance and colors of the tire.

To achieve the foregoing objective, a tire protection device of the present invention includes an annular wall and two centripetal lip portions extending inwards from two side ends of the annular wall in a radial direction respectively. The annular wall includes an accommodating space internally for receiving a tier. The annular wall further includes internal and external surfaces spaced in the radial direction. Concave and convex patterns are formed on the internal surface of the annular wall to match tread patterns on a tread of the tire. The tread of the tire is wrapped by the annular wall with the lip portions compactly covering two sidewalls of the tire when the tire is received in the accommodating space.

In a preferred form, an inner diameter of the annular wall is slightly greater than or equal to an outer diameter of the tire, and a spacing between the two lip portions is not less than a width of the tire. Patterns and textures are formed on the external surface of the annular wall and the lip portions respectively.

In a preferred form, each of the lip portions covers approximate half one of the sidewalls of the tire in the radial direction.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 is a perspective view of a tire protection device according to an embodiment of the present invention installed on a tire.

FIG. 2 shows a perspective view of the tire protection device of FIG. 1 separated from the tire.

FIG. 3 is a perspective view of a tire protection device according to another embodiment of the present invention installed on the tire.

### DETAILED DESCRIPTION OF THE INVENTION

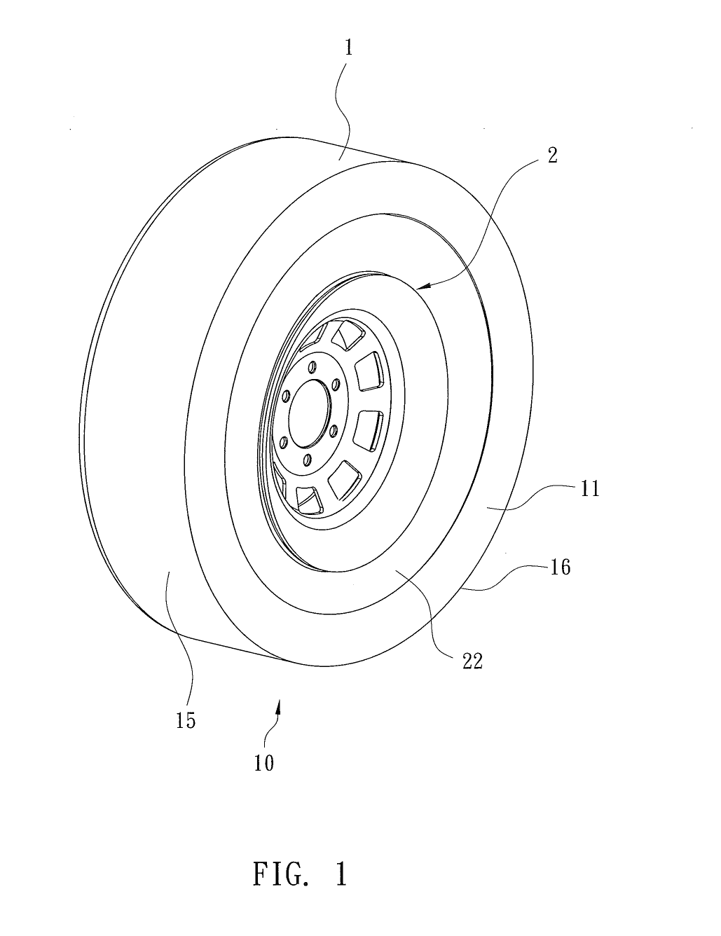

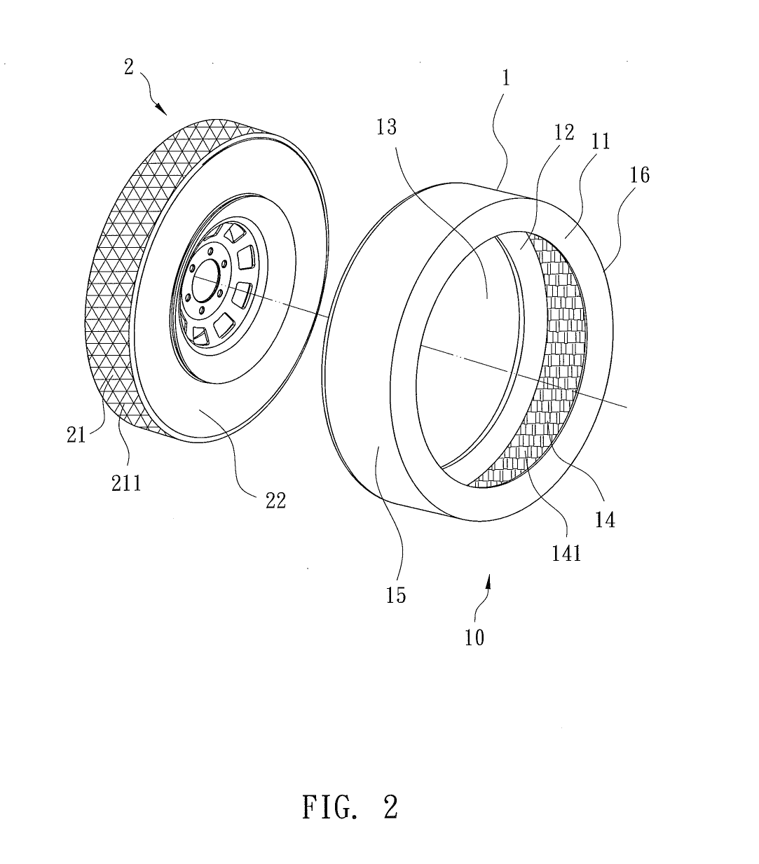

A tire protection device of an embodiment of the present invention is shown in FIGS. 1 and 2 of the drawings and generally designated 10. The tire protection device 10 is adapted to externally cover a tire 2 and to prevent a tread 21 of the tire 2 from direct friction with pavements. The tire protection device 10 includes a ring-shaped annular wall 1 and two centripetal lip portions 11, 12 extending inwards from two side ends 16 of the annular wall 1 in a radial direction respectively. The annular wall 1 includes an accommodating space 13 internally and internal and external surfaces 14 and 15 spaced in the radial direction. The accommodating space 13 is defined by the internal surface 14 and the lip portions 11, 12 collectively. An inner diameter of the annular wall 1 is slightly greater than or equal to an outer diameter of the tire 2, and a spacing between the two lip portions 11, 12 is not less than a width of the tire 2 (or the distance between two sidewalls 22 of the tire 2), so that the tire 2 can be held in the accommodating space 13 of the annular wall 1. In one embodiment of installation, the tire 2 is deflated and then received in the accommodating space 13 of the annular wall 1. Furthermore, staggered concave and convex patterns 141 are formed on the internal surface 14 of the annular wall 1 to match tread patterns 211 on the tread 21 of the tire 2. Accordingly, the patterns 141 on the internal surface 14 of the annular wall 1 will tightly contact the tread patterns 211 on the tread 21 of the tire 2, and the lip portions 11, 12 can compactly cover the sidewalls 22 of the tire 2 with the tire 2 inflated, so that the tread 21 of the tire 2 is securely wrapped by the annular wall 1. In this embodiment, the lip portion 11 (or the lip portion 12) covers approximate half one of the sidewalls 22 of the tire 2 in the radial direction.

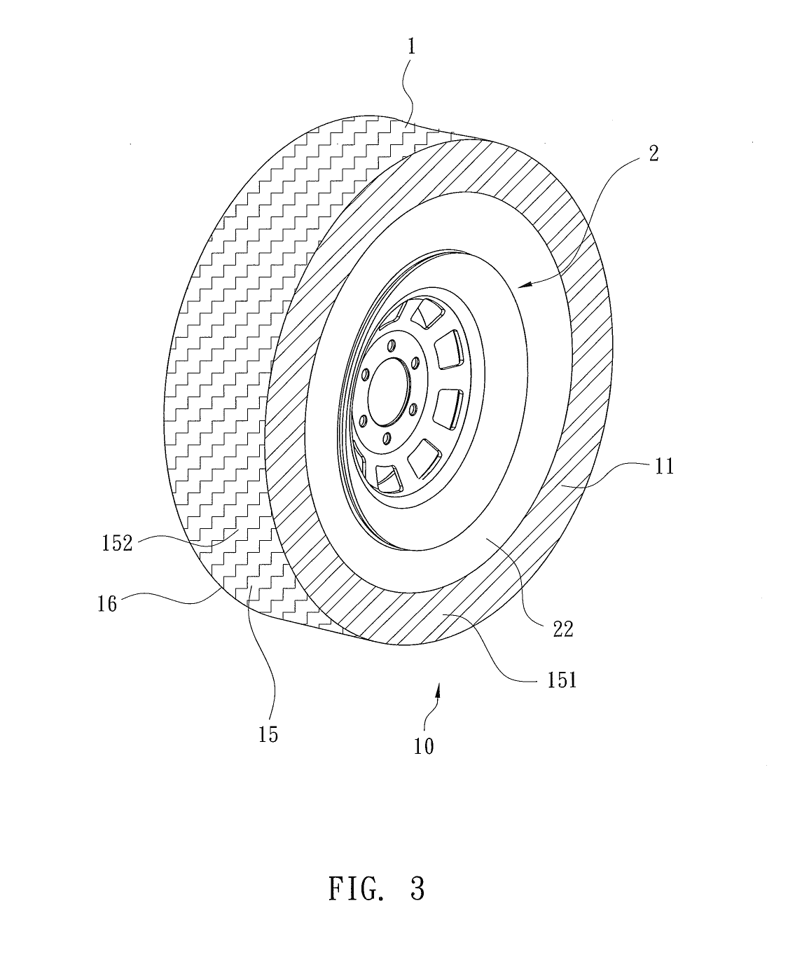

FIG. 3 shows an alternative embodiment of the tire protection device 10 according to the present invention. In the embodiment, unspecified patterns 152 and textures 151 are respectively formed on the external surface 15 of the annular wall 1 and the lip portions 11, 12 to increase the friction of the annular wall 1, embellish the tire 2, and make a car with the tire protection devices 10 have distinguishing colors.

The car with the tire protection devices 10 installed on the tires 2 for running on a road allows the external surfaces 15 of the annular walls 1 to replace the treads 21 of the tires 2 and to contact pavements without direct friction-induced wear between the tires 2 and pavements. In addition, the new tire protection device 10 substitutes for an old one removed because of the annular wall 1 worn and unserviceable to realize neither renewal of any tires nor the abandoned and environmental-unfriendly tires. On the other hand, the patterns 152 and the textures 151 on the annular wall 1 and the lip portions 11, 12 also optimize visual aesthetics of the tire 2.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A tire protection device comprising an annular wall and two lip portions extending inwards from two side ends of the annular wall in a radial direction respectively, with the annular wall including an accommodating space internally for receiving a tier, with the annular wall further including internal and external surfaces spaced in the radial direction, with concave and convex patterns formed on the internal surface of the annular wall, wherein a tread of the tire is wrapped by the annular wall with the lip portions compactly covering two sidewalls of the tire when the tire is received in the accommodating space.

2. The tire protection device according to claim 1, with an inner diameter of the annular wall being slightly greater than or equal to an outer diameter of the tire, with a spacing between the two lip portions being not less than a width of the tire.

3. The tire protection device according to claim 2, with patterns and textures respectively formed on the external surface of the annular wall and the lip portions.

4. The tire protection device according to claim 2, with each of the lip portions covering approximate half one of the sidewalls of the tire in the radial direction.
